(19) United States
(12) Patent Application Publication
(10) Pub. No.: US 2026/0333409 A1
(43) Pub. Date: Oct. 22, 2026

(54) AUTOMATED NETWORK RESOURCE ALLOCATION BASED ON PRIORITY SCHEDULING

(71) Applicant: T-MOBILE INNOVATIONS LLC, Overland Park, KS (US)

(72) Inventors: Mochamad Mirza, Bothell, WA (US); Jose Manuel Tapia Ruiz, Bothell, WA (US)

(21) Appl. No.: 19/186,082

(22) Filed: Apr. 22, 2025

(51) Int. Cl. H04W 72/542; H04W 72/044; H04W 72/566

(52) U.S. Cl. CPC H04W 72/542; H04W 72/044; H04W 72/566

(57) ABSTRACT

Systems, methods, and software are disclosed herein for allocating network resources based on priority scheduling, including establishing network service, via an access node of the wireless communication network, for a UE according to a priority status of the UE with respect to a priority domain of the access node. The method also includes monitoring a performance metric of the network service for the UE with respect to a target value that is determined based on service requirements of the UE and, in response to detecting a change in the performance metric based on the target value, modulating an allocation of network resources of the access node to the UE until the performance metric is within a specified margin of the target value.

### TECHNICAL FIELD

Aspects of the disclosure are related to the field of wireless communication networks, particularly time-frequency block scheduling.

### BACKGROUND

In wireless communication networks, access nodes such as eNodeBs in LTE or gNodeBs in 5G are responsible for dynamically allocating limited radio resources among multiple UEs. This allocation is performed by a scheduler operating at the MAC layer, which considers various inputs including channel quality, buffer status, and quality of service (QoS) parameters. Relative priority scheduling is one approach used by the scheduler to arbitrate resource allocation among UEs by assigning each UE a priority level that is evaluated relative to other active UEs. These priority levels are influenced by factors such as QoS profiles (e.g., QCI or 5QI), bearer type (GBR or non-GBR), and operator-defined policy rules.

The scheduler uses relative priority levels to determine which UEs are served first and how resources such as time-frequency units or resource blocks are distributed among them. These priorities are not static and may be adjusted in real time based on changing service requirements, network congestion, or mobility events. For instance, a UE engaged in a low-latency application with a high-priority 5QI may be scheduled ahead of UEs with lower-priority traffic during resource contention. This flexible, comparative approach allows the network to balance efficiency and fairness while meeting diverse service requirements across multiple UEs.

### OVERVIEW

Technology is disclosed herein for automated network resource allocation based on priority scheduling for wireless communication networks in various implementations. In one example, a computing apparatus comprises one or more computer readable storage media, one or more processors operatively coupled with the one or more computer readable storage media and program instructions stored on the one or more computer readable storage media that, when executed by the one or more processors, direct the computing apparatus to establish network service, via an access node of a wireless network, for a UE according to a priority status of the UE with respect to a priority domain of the access node and to monitor a performance metric of the network service for the UE with respect to a target value that is determined based on service requirements for the UE. The program instructions further direct the computing apparatus to detect a degradation of the performance metric and, in response to detecting the degradation of the performance metric, modulate an allocation of network resources of the access node to the UE until the performance metric achieves the target value.

In another example, a method of operating a computing device includes establishing network service, via an access node of the wireless communication network, for a UE according to a priority status of the UE with respect to a priority domain of the access node. The method also includes monitoring a performance metric of the network service for the UE with respect to a target value that is determined based on service requirements of the UE and, in response to detecting a change in the performance metric, modulating an allocation of network resources of the access node to the UE until the performance metric is within a specified margin of the target value.

In yet another example of the technology disclosed herein, one or more computer readable storage media having program instructions stored thereon that, when executed by one or more processors, direct a computing device to establish network service, via an access node of a wireless network, for a user equipment (UE) according to a priority status of the UE with respect to a priority domain of the access node. The computing device monitors a performance metric of the network service for the UE with respect to a target value that is determined based on service requirements of the UE. The computing device detects a degradation of the performance metric; and, in response to detecting the degradation of the performance metric, modulates an allocation of network resources of the access node to the UE until the performance metric achieves the target value.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for automated network resource allocation based on priority scheduling in an implementation.

FIG. 2 illustrates a process for automated network resource allocation based on priority scheduling in an implementation.

FIG. 3 illustrates a workflow for automated network resource allocation based on priority scheduling in an implementation.

FIG. 4 illustrates an operational scenario for automated network resource allocation based on priority scheduling in an implementation.

FIG. 5 illustrates an operational architecture of a wireless communication network in an implementation.

FIG. 6 illustrates a network architecture for a network core in an implementation.

FIG. 7 illustrates a computing system suitable for implementing the various operational environments, architectures, processes, scenarios, and sequences discussed below with respect to the other Figures.

### DETAILED DESCRIPTION

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

In wireless communication networks, when a user equipment (UE) attaches to an access node of the wireless network (e.g., to initiate a voice all or data session), the scheduler of the access node allocates time-frequency resources (e.g., resource blocks) to the UE based on service requirements for the UE such as the Quality of Service (QoS) profile associated with the UE's session. For instance, the QoS profile of the UE may specify a minimum guaranteed bit rate (GBR) or throughput. To meet these requirements, the scheduler allocates a sufficient number of resource blocks to the UE during each scheduling interval. However, in congested network conditions, if the UE experiences poorer signal quality (for example, by moving away from the access node), the achievable throughput may degrade and fall below the specified minimum GBR, leading to a QoS shortfall.

Various implementations are disclosed herein for automated network resource allocation based on prioritization scheduling in wireless communication networks to maintain a QoS for priority UEs. When a priority UE undergoes service degradation, such as a degradation in throughput, the access node can upgrade the throughput to the UE by modulating the allocation of resource blocks for that UE. By increasing the number resource blocks available for network service to the UE, the achievable throughput is improved to meet the service requirements of the UE. The access node continually monitors the quality of the network service to the UE, including maintaining the allocation of resource blocks when the throughput meets the QoS of the UE and decreasing the allocation of resource blocks if the throughput exceeds the QoS of the UE. Thus, the access node can respond automatically to changes in service quality arising from traffic congestion and varying radio frequency (RF) conditions by modulating the allocation of resource blocks available for service to the UE.

In various implementations, modulating the allocation of the resource blocks is managed by a medium access control (MAC) scheduler at the access node. When a UE attaches to the access node, the MAC scheduler determines a scheduling weight for the UE for allocating network resources according to the service requirements of the UE. The service requirements of the UE can include QoS parameters, network slice attributes, application type, and other factors that influence how the network should deliver service to that UE. For example, a high-priority UE may be assigned a higher scheduling weight than lower priority UEs. The higher scheduling weight enables a greater allocation of resource blocks to ensure the more demanding service requirements for the high-priority UE are met.

As network service is provided to the UE, if the RF conditions to the UE cause a degradation in performance (e.g., a degradation in throughput), the scheduler may incrementally increase the scheduling weight of the UE, thereby increasing the quantity of resource blocks available to the UE and improving the quality of the network service to the UE until the service requirements of the UE are met. The scheduler continues to monitor the quality of the network service to the UE and modulate the scheduling weight of the UE (and therefore the quantity of available resource blocks to the UE) to maintain the QoS.

To modulate the allocation of resource blocks to maintain network service quality (e.g., throughput) for a priority UE, the scheduler of the access node may determine a target throughput for the priority UE based on its QoS of the UE, the applicable network slice, and other factors and modulate the scheduling weight of the UE to ensure that the throughput to the UE is at the target throughput or within a specified margin of the target throughput. In some scenarios, the target throughput is an average throughput (e.g., average downlink throughput) for multiple UEs of the applicable network slice. By monitoring the throughput to the UE at regular intervals (e.g., regular scheduling intervals), the scheduler can step up, step down, or maintain the scheduling weight of the UE in response to the detected throughput. For example, when a degradation in throughput is detected, the MAC scheduler may incrementally increase the scheduling weight until the desired throughput is achieved or until the detected throughput is within a specified margin of the desired throughput. Similarly, if, after boosting the scheduling weight of the UE, if the scheduler detects that the throughput has now exceeded the desired throughput or exceeded a specified margin of the desired throughput, the scheduler may incrementally decrease the scheduling weight of the UE until the detected throughput is within a specified margin of the desired throughput.

In some implementations of the technology disclosed herein, the incremental adjustments in the scheduling weight may be constant regardless of how far out of range the detected throughput is from the target throughput. In some cases, however, the incremental adjustments may be determined based on how degraded the detected throughput is from the target throughput—a larger deviation from the target throughput may indicate a larger step size in adjusting the scheduling weight. In some implementations, an automated process of modulating network resources is implemented when heightened congestion is detected in data traffic at an access node; under conditions of heightened congestion, the process may monitor network performance with respect to priority UEs and perform incremental adjustments of the scheduling weights to achieve or maintain service requirements for those UEs. In some implementations, lower priority UEs (e.g., such as UEs which do not have a throughput requirement) may be excluded from automated modulation of network resources when network service to those UEs degrades. In some scenarios, a performance shortfall with respect to latency may trigger the automated modulation of the network resources via the priority scheduling for a priority UE.

Technical effects of the technology disclosed herein include a system for maintaining or improving network service for priority users in challenging RF environments by automating the allocation of network resources of the access node to which the priority users are attached. To allocate network resources of the access node to priority users, the system identifies UEs according to their priority status and assigns a scheduling weight to meet the service requirements of those users; to adjust the allocation of network resources to a UE, the system incrementally adjusts the scheduling weight of the UE. By providing a mechanism for adjusting the allocation of resource blocks to priority users using the scheduling weight, the network can respond more quickly to a situation in which a degradation in performance is detected, such as in a challenging RF environment. Further, adjustments can be made to increase, decrease, or maintain the allocation of resources to a UE so that if the RF environment of UE improves, the system responds by automatically reducing the scheduling weight and therefore the corresponding allocation of resources. Thus, not only is the system responsive to changes in the RF conditions, any adjustment to the allocation of network resources occurs on an as-needed, where-needed basis.

Moreover, the technology disclosed herein further provides for modifying a resource allocation on the basis of priority scheduling within a priority domain of an access node. By allocating or reallocating network resources on a competitive basis amongst users of varying priority statuses, the distribution of network resources is optimized to improve or maintain network performance to higher-priority users.

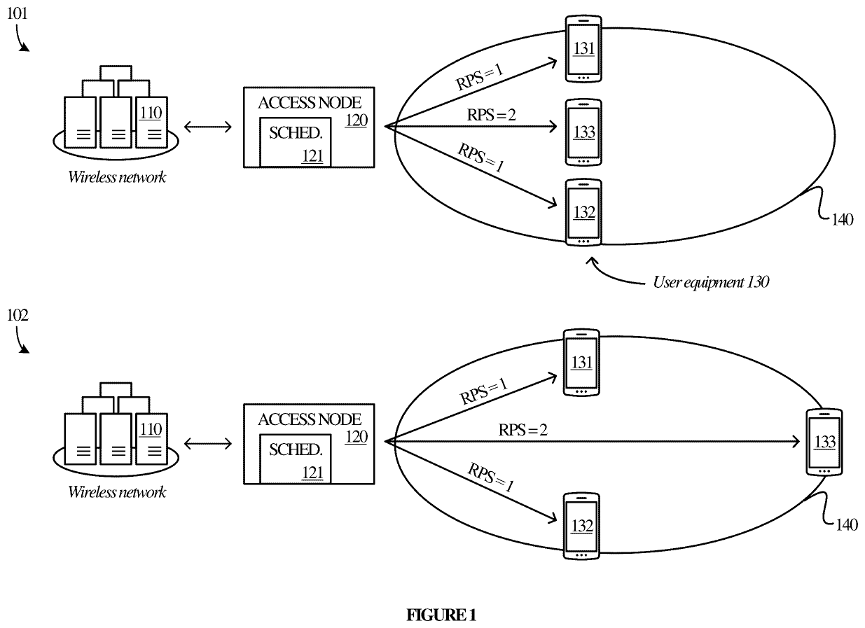

Turning now to the Figures, FIG. 1 illustrates operational environments 101 and 102 depicting various stages of operation for automated modulation of network resources based on priority scheduling for wireless communication networks in an implementation. Operational environments 101 and 102 include wireless network 110, access node 120, scheduler 121, priority domain 140, and UEs 131, 132, and 133 (collectively, UEs 130).

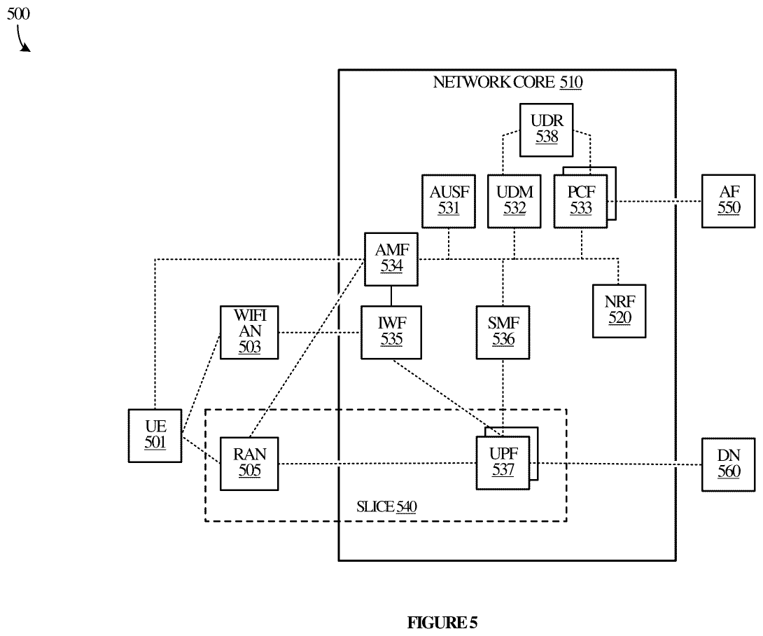

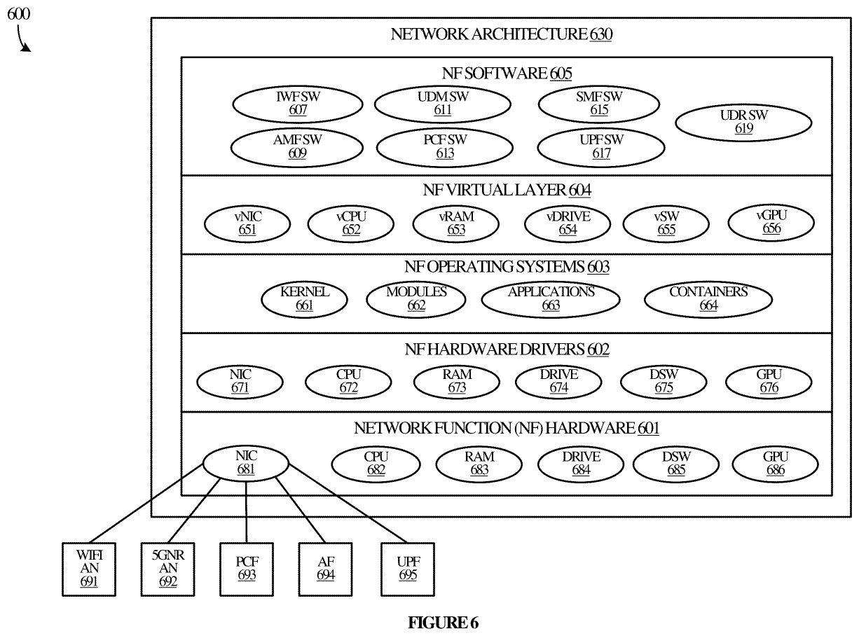

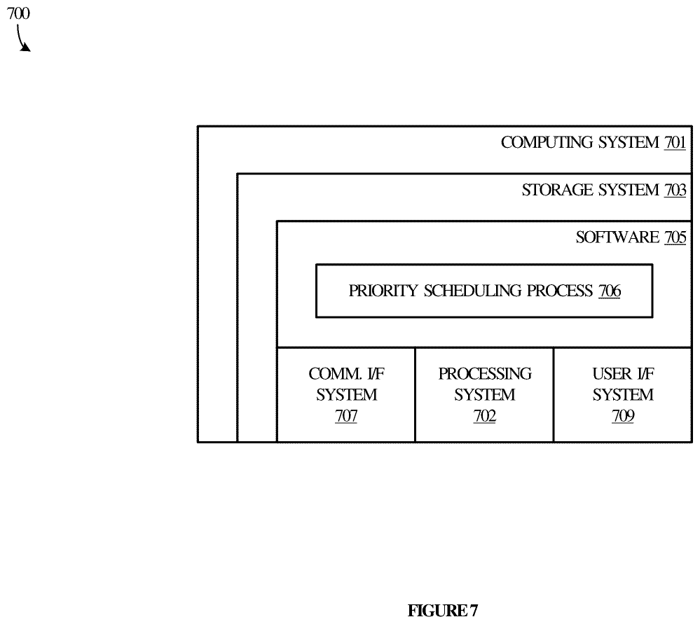

Wireless network 110 is representative of a communication network capable of using a Fifth Generation New Radio (5G-NR),4G or Long-Term Evolution (LTE), 6G, or other protocol to communicate with computing devices such as UEs 130. In some implementations, wireless network 110 is representative of a service-based architecture (SBA) which includes network functions which constitute the control plane and user plane of a wireless communication network core, of which network data center 510 of FIG. 5 and network data center 630 of FIG. 6 are representative. In some scenarios, wireless network 110 is representative of an evolved packet core (EPC) architecture which uses dedicated interfaces between network functions to manage network access, mobility, and data transmissions. In still other scenarios, wireless network 110 is a hybrid architecture including elements of SBA and EPC architectures, such as a 5G Non-Standalone (5GNSA) architecture. The network functions of wireless network 110 are implemented on one or more suitable computing devices, of which computing device 701 of FIG. 7 is representative. Examples of suitable computing devices include server computers, blade servers, and the like. The network elements of wireless network 110 may be implemented in the context of one or more data centers in a co-located or distributed manner, or in some other arrangement.

Access node 120 is representative of equipment to which a UE connects for network service (e.g., voice calls, data service) of a wireless communication network. Access node 120 can include a Fifth Generation (5G) radio access network (RAN), an access node of long-term evolution (LTE) RAN, a gNodeB, a eNodeB, a macrocell, a NB-IoT access node, an LP-WAN base station, a wireless relay, a Wifi access node, a satellite terminal, or other wireless or wireline network transceiver. Access node 120 hosts access networks using radio frequencies (including satellite communication frequencies) to provide wireless network connectivity to devices such as UEs 130. To communicate with a network core of wireless network 110, access node 120 may include receiving unit (RU) circuitry which communicates along fronthaul data paths to distributed unit (DU) circuitry which in turn communicates with central unit (CU) circuitry along midhaul data paths. Access node 120 can include terrestrial configurations such as cell towers and small cells, as well as non-terrestrial configurations including on-orbit access nodes, such as satellite-based systems operating as part of an NTN architecture. Other configurations of access node 120 include cell towers, rooftop installations, small-cell sites, distributed antenna systems, vehicle-mounted systems, airborne access nodes, and the like.

Scheduler 121 of access node 120 is representative of functionality configured to allocate radio resources of access node 120, such as time-frequency blocks, amongst multiple UEs attached to access node 120 based on scheduling algorithms that consider factors such as channel conditions, QoS requirements, traffic type, or priority levels. Scheduler 121 can include MAC scheduler of access node 120.

UEs 130 are representative of devices, such as a smartphone, computer, sensor, controller, radio, and/or some other user apparatus, with processing circuitry for wireless communication with wireless network 110. UEs 130 may communicate with wireless network 110 using a protocol such as Fifth Generation New Radio (5GNR), 5G Advanced, LTE, 6G, Institute of Electrical and Electronic Engineers (IEEE) 802.11 (Wifi), Low-Power Wide Area Network (LP-WAN), Near-Field Communications (NFC), Code Division Multiple Access (CDMA), Frequency Division Multiple Access (FDMA), and Time Division Multiple Access (TDMA). UEs 130 can include devices such as Internet of Things (IoT) devices, wearable devices, smart vehicles, robots, sensors, augmented or virtual reality devices, and the like, such as a laptop or desktop computer, or mobile computing device, such as a tablet computer or cellular phone, of which computing system 701 in FIG. 7 is broadly representative. UEs 130 exchanges wireless communication signals with access node 120 of wireless network 110 over radio frequency bands. In some examples, functionality attributed to a UE is distributed between or amongst multiple devices. For example, a mobile handset may be augmented with satellite connectivity using an auxiliary device for direct-to-satellite connectivity.

Priority domain 140 of access node 120 is representative of a logical or physical domain of access node 120 that is associated with prioritization of network traffic or resource allocation. Priority domain 140 may be configured to apply a prioritization scheme, such as a Relative Priority Scheduling (RPS), to manage access to network resources among connected user equipment (UEs) based on service requirements such as quality of service (QoS) class, user priority, application type, network slicing, or channel conditions. Priority domain 140 may be implemented in association with radio scheduling components, QoS enforcement mechanisms, or traffic steering logic of access node 120, enabling differentiated service levels within the wireless communication network. As depicted in FIG. 1, within priority domain 140, UEs 131 and 132 represent UEs assigned a normal or baseline priority status or scheduling weight (“RPS=1”) while UE 133 is assigned a higher weight (“RPS=2”). The RPS value or scheduling weight may reflect a relative share of available radio resources compared to other UEs actively being served by the access node.

A brief operational scenario of operational environments 101 and 102 follows. In operational environment 101, UEs 130 are attached to access node 120 to receive network service hosted by wireless network 110. Scheduler 121 of access node 120 determines a relative priority scheduling for each of the UEs in priority domain 140 (including UEs 130) based on factors such as channel conditions, QoS requirements, traffic type, or priority levels. As illustrated, UEs 131 and 132 are assigned a normal priority status, which UE 133 is assigned a higher priority status. Scheduler 121 monitors performance indicators which describe the quality of service provided to UEs 130 to ensure that each of UEs 130 receive network service in accordance with respective QoS requirements. For example, scheduler 121 monitors the throughput between access node 120 and the various devices against the target throughput values based on the respective service requirements.

Continuing with the brief operational scenario in operational environment 102, at some point during the delivery of network service to UEs 130, UE 133 has moved away from access node 120. As a result of the increased distance, the signal quality degrades. To address the signal degradation, access node 120 implements a more robust modulation and coding scheme (MCS) which, in turn, causes throughput to UE 133 to fall below the target throughput specified by the service requirements for that device. To improve the throughput to UE 133, scheduler 121 increases the scheduling weight of UE 133 so that more resources of access node 120 can be used to improve the throughput with respect to UE 133. Scheduler 121 continues to step up the scheduling weight assigned to UE 133 until the detected throughput reaches the target throughput for that device. Once the target throughput is reached, scheduler 121 continues to monitor the throughput to ensure that the target throughput is maintained. For example, if UE 133 moves closer to access node 120 or if the RF environment improves, the throughput to UE 133 may exceed the target throughput. As a result, scheduler 121 may step down the scheduling weight of UE 133 until the detected throughput is at or within a specified margin of the target throughput value.

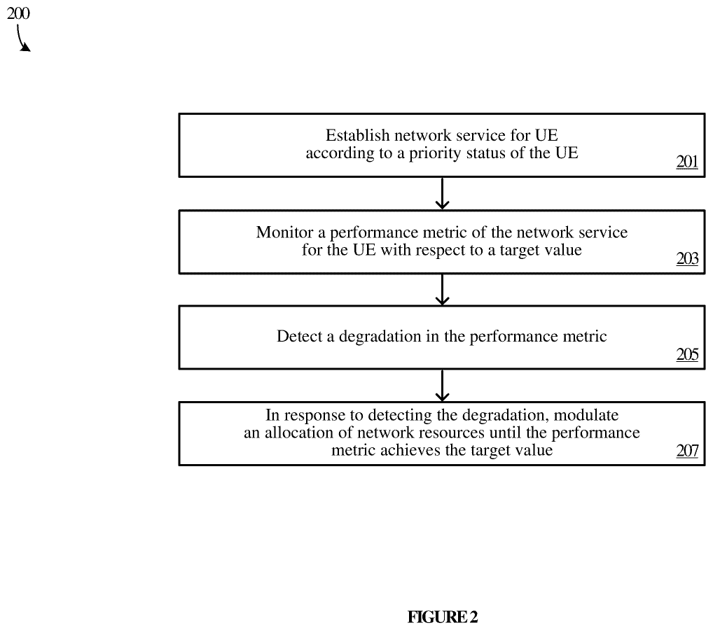

FIG. 2 illustrates a method of automated network resource allocation based on priority scheduling for wireless communication networks in an implementation, herein referred to as process 200. Process 200 may be implemented in program instructions in the context of any of the software applications, modules, components, or other such elements of one or more computing devices. The program instructions direct the computing device(s) to operate as follows, referred to in the singular for the sake of clarity.

In process 200, the computing device establishes network service for a UE according to a priority status of the UE (step 201). In an implementation, a UE attaches to an access node of a wireless communication network for network service, such as a voice call, Internet access, or the like. A scheduler of the access node establishes a radio bearer according to QoS parameters associated with the UE which indicate that the UE is a priority user (e.g., has a higher priority status than a normal or baseline priority status). For example, the scheduler may determine that the UE is a priority user based on QoS parameters received from the core network during session setup, such as a high Allocation and Retention Priority (ARP) value or a QoS identifier (QCI/5QI) associated with mission-critical or premium services. Additionally or alternatively, the scheduler may reference pre-configured policies or subscriber profiles indicating elevated priority status for certain users, such as emergency responders or enterprise customers. In any case, having identified the priority status of the user, the scheduler assigns a scheduling weight to the UE based on its priority status and allocates resource blocks to the UE according to the scheduling weight. The scheduling weight influences the likelihood or frequency with which the UE is granted access to available resource blocks, thereby enabling differentiated treatment of network traffic.

In an implementation, the access node applies a prioritized scheduling, such as a Relative Priority Scheduling (RPS) scheme, of network resources to a priority domain of UEs attached to the access node. Within the priority domain, the access node evaluates the priority status of each UE and interfaces with the scheduler to influence scheduling decisions, i.e., when and to whom resource blocks are allocated. In particular, the priority domain may assign scheduling weights, determine prioritization levels, or classify UEs based on factors such as subscription plan, application type, emergency status, or network slice association. Classifications of the UEs may be used to drive the scheduler's allocation of resource blocks, thereby enabling consistent application of prioritization policies across multiple UEs and traffic types within the wireless communication network.

The computing device monitors a performance metric of network service for the UE with respect to a target value (step 203). In an implementation, at regular scheduling intervals (e.g., at 1-millisecond intervals), the scheduler monitors network performance metrics including uplink and downlink throughput to the UE. By tracking the volume and rate of successfully transmitted data over time, the scheduler can assess whether QoS targets and priority-based performance expectations are being met over the duration of the radio bearer. At each interval, throughput measurements may be collected per UE or per bearer using techniques such as monitoring medium access control (MAC) layer throughput, measuring acknowledged transport block sizes, or analyzing application-layer traffic flows. Throughput measurements may reflect both instantaneous throughput and averaged performance over defined time windows. The detected throughput of the UE is compared to a target throughput indicated by the QoS for the UE for a given network slice or application to determine if a performance shortfall has occurred.

The computing device detects a degradation in the performance metric based on the target value (step 205). As the computing device monitors the detected throughput with respect to the target throughput, the computing device may determine that the detected throughput is below the target throughput or has fallen below a range of target throughput values and initiate a response if the deviation exceeds a predetermined margin. For example, if the target downlink throughput is 10 Mbps (e.g., for a priority UE for video conferencing) but the detected downlink throughput at the most recent measurement interval is 6 Mbps (e.g., measured at the MAC layer by totaling acknowledged transport block sizes), the deviation in throughput performance is 4 Mbps below the target value. If an acceptable deviation is, for example, 0.5 Mbps, then a response to improve network performance to the UE would be initiated on the basis of the deviation. In some cases, the detected throughput is compared to a range of values spanning the target throughput, and a response may be initiated if the detected throughput falls outside the range. For example, if a specified margin of acceptable performance is plus/minus 0.5 Mbps of the target value (i.e., 9.5-10.5 Mbps). In some scenarios, the computing device may monitor the performance metric or throughput for degradation over a period of time. For example, if the shortfall persists over several consecutive scheduling intervals, the response may then be initiated.

In response to detecting the degradation in the performance metric, the computing device modulates an allocation of network resources until the performance metric achieves the target value (step 207). In an implementation, having identified a shortfall in network performance to the priority UE, at a scheduling interval, the computing device incrementally increases the scheduling weight of the priority UE. By increasing the scheduling weight of the priority UE, the UE will receive more frequent or larger allocations of time-frequency resources of the access node improving network performance (e.g., throughput). With the scheduling weight adjusted (increased), the scheduler monitors the detected throughput with respect to the target throughput during the next scheduling interval. If a shortfall is still detected, the scheduling weight is again increased. The process of incrementally adjusting the scheduling weight continues until the detected throughput achieves the target throughput. In some cases, achieving the target throughput entails determining that the detected throughput is at or above the target throughput or that the detected throughput is within a specified margin of the target throughput.

With the target throughput achieved, the newly adjusted scheduling weight of the priority UE is held constant, and the scheduler continues to monitor the performance metrics for changes in detected throughput relative to the target throughput. Should the scheduler determine that the detected throughput is exceeding the target throughput, the scheduler may incrementally adjust the scheduling weight downward until the detected throughput is at or within an acceptable range of the target value. In some cases, adjusting the scheduling weight may depend on the magnitude of the deviation so that a more aggressive adjustment can be made for a large deviation or a more modest adjustment can be made for a smaller one. In some scenarios of process 200, adjustments to the scheduling weight are determined based on improving network performance with respect to latency.

Referring again to FIG. 1, a brief example of process 200 as employed by elements of operational environments 101 and 102 follows. In operational environment 101, UEs 130 are attached to wireless network 110 for network service via access node 120. UEs 130 occupy priority domain 140 of access node 120 by which a prioritization scheme, such as RPS, is applied to competitively distribute network resources (e.g., resource blocks) amongst UEs 130 according to their priority statuses. Scheduler 121 determines, based at least on the QoS parameters of the respective devices, that UEs 131 and 132 have a normal priority (“RPS=1”) which UE 133 has a higher priority (“RPS=2”). While UEs 130 are in service with respect to wireless network 110, scheduler 121 monitors performance metrics of at least UE 133 against the QoS parameters for that UE. For example, scheduler 121 may monitor throughput and latency to ensure UE 133 is receiving service in accordance with its QoS.

Continuing with the brief example of process 200, in operational environment 102, while UE 133 is in service with respect to wireless network 110, UE 133 moves away from access node 120, causing weaker signaling between UE 133 and access node 120. As a result, access node 120 determines, based on a CQI report from UE 133, that signaling quality to UE 133 has degraded. In response, scheduler 121 implements a more robust modulation and coding scheme (MCS) to maintain reliable communication with UE 133. However, because the more robust MCS will carry less data per resource block, UE 133's effective throughput using the more robust MCS is decreased.

Scheduler 121 determines that UE 133's throughput has fallen below a target throughput for the device. Scheduler 121 begins a process of incrementally adjusting the scheduling weight of UE 133 to improve network performance, such as throughput, to UE 133. At each scheduling interval, scheduler 121 evaluates the detected throughput to UE 133 against a target value. If the detected throughput falls short of the target value, scheduler 121 upgrades the scheduling weight of UE 133 (e.g., increasing the RPS value of UE 133 to 3, 4, 5, and so on). When the detected throughput reaches the target throughput, scheduler 121 holds the scheduling weight constant. Scheduler 121 continues to monitor the network performance for UE 133. If scheduler 121 determines that the detected throughput has exceeded the target throughput, scheduler 121 incrementally downgrades the scheduling weight at each scheduling interval until the detected throughput achieves the target value. In various implementations, determining that the detected throughput meets the target value can include determining that the detected throughput is within a specified range of the target value. Similarly, determining that the detected throughput has fallen short of the target throughput or exceeds the target throughput can include determining that the detected throughput is below or above a range of values spanning the target throughput.

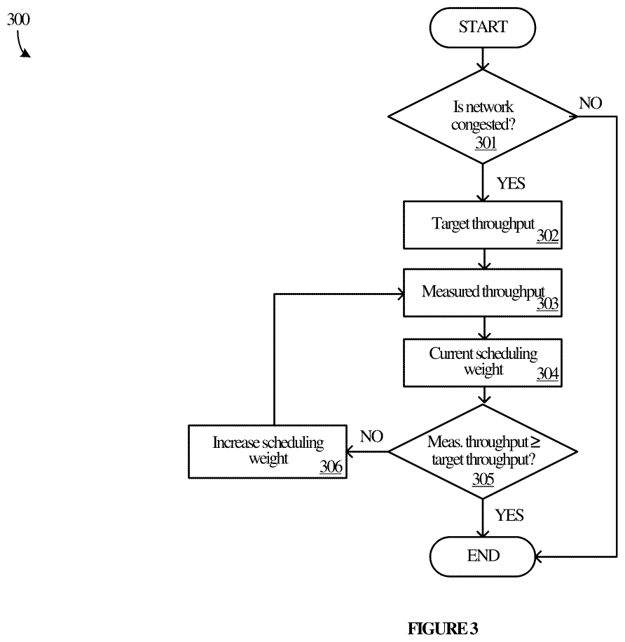

Turning now to FIG. 3, FIG. 3 illustrates workflow 300 for automated network resource allocation based on priority scheduling in an implementation. Workflow 300 may be performed with respect to a higher-priority UE at an access node undergoing data traffic congestion. Workflow 300 may be performed by a functionality for scheduling time-frequency units amongst UEs of an access node, such as scheduler 121 of FIG. 1. Steps 303-306 may be performed during each scheduling interval of a series of scheduling intervals.

Workflow 300 begins with assessing data traffic for congestion at the access node (step 301). For example, the scheduler may assess traffic congestion based on the number of UEs competing for resources of the access node or on resource block usage. Upon determining that the access node is undergoing a heightened level of congestion (“YES”), the scheduler monitors network performance to priority UEs to detect and address any degradation in service. The scheduler determines the target throughput for a higher-priority UE based on the service requirements of the UE (e.g., QoS of the UE) (step 302). The target throughput may be determined based on QoS requirements of the priority UE together with other factors such as associated network slice or application, subscriber data, and so on.

The scheduler also detects the throughput (step 303) and the current scheduling weight (step 304) of the UE. The throughput may be detected at the MAC or PDCP layers, while the scheduling weight was assigned by the scheduler based on the service requirements of the UE when the UE attached to the access node. The scheduler then compares the measured throughput to the target throughput to determine if there is a performance shortfall (step 305). The shortfall may be due to the congestion at the access node exacerbated by a degradation in the RF environment. For example, in the congested environment, the throughput to the UE may be maintained based on its normal allocation of the resource blocks, but if the UE moves away from the access node, this may cause weaker signaling and a resulting decline in throughput due to the need for a more robust MCS.

Continuing with workflow 300, if the scheduler determines that the measured throughput is below the target throughput for the UE, the scheduler increases the scheduling weight of the UE (step 306). By increasing the scheduling weight, more resource blocks of the access node are available for use by the UE resulting in increased throughput.

At the next scheduling interval, the scheduler again measures the throughput of the UE (step 303) and compares the measured throughput to the target throughput (step 305). If the measured throughput is still short of the target throughput, the scheduler again steps up the scheduling weight. When the measured throughput achieves the target throughput, the scheduler does not change the scheduling weight for the UE.

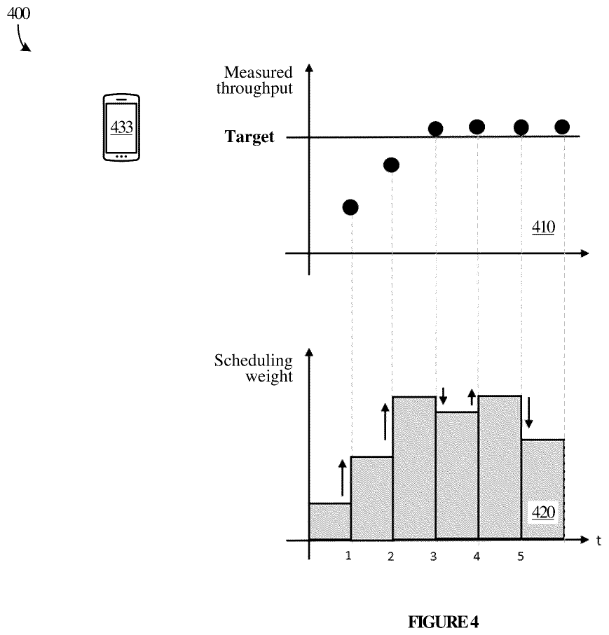

FIG. 4 depicts operational scenario 400 for automated network resource allocation based on priority scheduling in an implementation. UE 433 is representative of a priority UE, such as UE 133 of FIG. 1, with service requirements including a minimum GBR or throughput. Chart 420 of FIG. 4 depicts the scheduling weight of UE 433 over several scheduling intervals; chart 410 of FIG. 4 depicts the measured throughput of UE 433 with respect to a target throughput as the scheduling weight of the UE is adjusted over the scheduling intervals.

In operation, UE 433 receives network service via an access node of a wireless communication network. Based on its service requirements, UE 433 is assigned a scheduling weight (at t=0 of chart 420) to provide prioritized access to network resources including resource blocks for uplink and downlink transmissions. The access node determines that there is congestion in the network data traffic carried by the access node, and in response institutes heightened monitoring of priority UEs.

Over the course of several scheduling intervals (i.e., t=1, 2, 3, and so on), a MAC scheduler of the access node monitors the throughput of UE 433 and adjusts the allocation of network resources to UE 433 in response to the throughput by adjusting its scheduling weight. The target throughput to which the throughput of UE 433 is compared may be an average throughput, such as an average downlink throughput, of other UEs in communication with the access node (or within the same priority domain as UE 433) which are served via the same network slice as UE 433. At t=1, the scheduler determines that the throughput for UE 433 has fallen short of the target throughput as depicted in chart 410. In response, the scheduler incrementally increases the scheduling weight of UE 433. At t=2, the scheduler detects that the throughput for UE 433 is still short of the target throughput and makes another incremental increase. At t=3, the scheduler determines that the measured throughput is at or above the target throughput as depicted in chart 410

Because the measured throughput can be affected by a number of factors beyond scheduling weight, the scheduler may continue to throttle the scheduling weight in order to achieve a minimal allocation of resource blocks for UE 433 to achieve the performance objectives for that device. For example, should RF conditions (e.g., as reflected in CQI reports from UE 433) or traffic congestion improve, the throughput to UE 433 may also improve absent any adjustment to the scheduling weight. Scheduling weight provides a lever by which the scheduler can respond to varying conditions to modulate network performance for the UE.

Continuing with operational scenario 400, from t=3 to t=5, when the measured throughput is above the target throughput, the scheduler may throttle back the scheduling weight to avoid allocating more resource blocks than is needed to achieve the performance objectives of the UE. At t=5, the scheduler steps down the scheduling weight and determines that the measured throughput is still achieving the target value.

In various implementations, determining whether the measured throughput has reached or achieved the target throughput may include determining that the measured throughput is within a specified margin of the target throughput. Put another way, when the measured throughput is within a range of acceptable throughput values, the scheduler may respond by maintaining the current scheduling weight. If the throughput exceeds the range of acceptable values, the scheduler can then downgrade the scheduling weight of the UE. In some scenarios, the step size for adjusting the scheduling weight may be determined based on how large the deviation is between the measured and target throughputs. Thus, by making incremental adjustments to the scheduling weight, the scheduler can seek to achieve and maintain the target throughput by a minimal or efficient allocation of network resources.

FIG. 5 illustrates exemplary wireless communication system 500 that serves wireless User Equipment (UE) 501 based on policies. Wireless communication system 500 includes UE 501, Wifi Access Node (AN) 503, 5GNR RAN 505, Network Repository Function (NRF) 520, Interworking Function (IWF) 535, Access and Mobility Management Function (AMF) 534, Authentication Server Function (AUSF) 531, Unified Data Management (UDM) 532, Policy Control Functions (PCFs) 533, Session Management Function (SMF) 536, User Plane Function (UPF) 537, Uniform Data Repository (UDR) 538, and Application Function (AF) 550. UDR 538 stores network data including subscriber profiles including identities, subscription details, service preferences, authentication credentials, and billing information. UDR 538 may also store policy data such as network rules, access rules, mobility rules, charging rules, and so on. AF 550 may provide policies applicable to control plane functions, that is, to the application, presentation, and/or session layers of the OSI protocol stack. IWF 535 includes non-3GPP IWFs (N3IWFs) for providing untrusted non-3GPP access to network data center 510, such as access via a non-cellular access network. Wireless network slice 540 is representative of a dynamically allocated slice of finite duration selected for hosting service from DN 560 to UE 501 according to the technology disclosed herein.

In FIG. 5, UE 501 attaches to RAN 505 for network service according to the technology disclosed herein including automated network resource allocation based on priority scheduling as described in various implementations in the preceding Figures.

FIG. 6 illustrates exemplary network data center 630, a network core of a wireless communication system, of which wireless network 110 of FIG. 1 is representative. Network data center 630 includes network function (NF) software 605, network function virtual layer 604, network function operating systems 603, network function hardware drivers 602, and network function hardware 601.

Network function software 605 of network data center 630 includes software for executing various network functions: IWF software 607, AMF software 609, UDM software 611, PCF software 613, SMF software 615, UPF software 617, and UDR software 619. Other network function software, such as network repository function (NRF) software, are typically present but are omitted for clarity.

Network function virtual layer 604 includes virtualized components of network data center 630, such as virtual NIC 651, virtual CPU 652, virtual RAM 653, virtual drive 654, virtual software 655, and virtual GPU 656. Network operating systems 603 includes components for operating network data center 630, including kernels 661, modules 662, applications 663, and containers 664 for network function software execution. Network function hardware drivers 602 include software for operating network function hardware 601 of network data center 630, including network interface card (NIC) drivers 671 for network interface cards (NICs) 681, CPU drivers 672 for CPUs 682, RAM drivers 673 for RAM 683, flash/disk drive drivers 674 for flash/disk drives 684, data switch (DSW) drivers 675 for data switches 685, and drivers 676 for GPUs 686. Network interface cards 681 of network function hardware 601 include hardware components for communicating with Wifi access node 691, 5GNR access node 692, PCF 693, application server 694, and UPF 695.

FIG. 7 illustrates computing device 701 that is representative of any system or collection of systems in which the various processes, programs, services, and scenarios disclosed herein may be implemented. Examples of computing device 701 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 701 may be implemented as a single apparatus, system, or device or may be implemented in a distributed manner as multiple apparatuses, systems, or devices. Computing device 701 includes, but is not limited to, processing system 702, storage system 703, software 705, communication interface system 707, and user interface system 709 (optional). Processing system 702 is operatively coupled with storage system 703, communication interface system 707, and user interface system 709.

Processing system 702 loads and executes software 705 from storage system 703. Software 705 includes and implements priority scheduling process 706, which is (are) representative of the priority scheduling processes discussed with respect to the preceding Figures, such as process 200 and workflow 300. When executed by processing system 702, software 705 directs processing system 702 to operate as described herein for at least the various processes, operational scenarios, and sequences discussed in the foregoing implementations. Computing device 701 may optionally include additional devices, features, or functionality not discussed for purposes of brevity.

Referring still to FIG. 7, processing system 702 may comprise a micro-processor and other circuitry that retrieves and executes software 705 from storage system 703. Processing system 702 may be implemented within a single processing device but may also be distributed across multiple processing devices or sub-systems that cooperate in executing program instructions. Examples of processing system 702 include general purpose central processing units, graphical processing units, application specific processors, and logic devices, as well as any other type of processing device, combinations, or variations thereof.

Storage system 703 may comprise any computer readable (or “computer-readable”) storage media readable by processing system 702 and capable of storing software 705. Storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 703 may also include computer readable communication media over which at least some of software 705 may be communicated internally or externally. Storage system 703 may be implemented as a single storage device but may also be implemented across multiple storage devices or sub-systems co-located or distributed relative to each other. Storage system 703 may comprise additional elements, such as a controller, capable of communicating with processing system 702 or possibly other systems.

Software 705 (including priority scheduling process 706) may be implemented in program instructions and among other functions may, when executed by processing system 702, direct processing system 702 to operate as described with respect to the various operational scenarios, sequences, and processes illustrated herein. For example, software 705 may include program instructions for implementing a priority scheduling process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 705 may include additional processes, programs, or components, such as operating system software, virtualization software, or other application software. Software 705 may also comprise firmware or some other form of machine-readable processing instructions executable by processing system 702.

In general, software 705 may, when loaded into processing system 702 and executed, transform a suitable apparatus, system, or device (of which computing device 701 is representative) overall from a general-purpose computing system into a special-purpose computing system customized to support scheduling weight modulation for network resource allocation in an optimized manner. Indeed, encoding software 705 on storage system 703 may transform the physical structure of storage system 703. The specific transformation of the physical structure may depend on various factors in different implementations of this description. Examples of such factors may include, but are not limited to, the technology used to implement the storage media of storage system 703 and whether the computer-storage media are characterized as primary or secondary storage, as well as other factors.

For example, if the computer readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 707 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 701 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

Unless the context clearly requires otherwise, throughout the description and the claims, the words “comprise,” “comprising,” “such as,” and “the like” are to be construed in an inclusive sense, as opposed to an exclusive or exhaustive sense, that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having operations, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
establish network service, via an access node of a wireless network, for a user equipment (UE) according to a priority status of the UE with respect to a priority domain of the access node;
monitor a performance metric of the network service for the UE with respect to a target value, wherein the target value is determined based on service requirements of the UE;
detect a degradation of the performance metric based on the target value; and
in response to detecting the degradation of the performance metric, modulate an allocation of network resources of the access node to the UE until the performance metric achieves the target value.

2. The computing apparatus of claim 1, wherein the network resources comprise time-frequency units of the access node which are assigned to the UE and wherein the performance metric comprises throughput.

3. The computing apparatus of claim 2, wherein to modulate the allocation of network resources of the access node to the UE, the program instructions direct the computing apparatus to incrementally adjust a scheduling weight of the UE until the performance metric achieves the target value.

4. The computing apparatus of claim 3, the program instructions further direct the computing apparatus to maintain the scheduling weight of the UE in response to detecting that the throughput achieves the target value.

5. The computing apparatus of claim 4, wherein the program instructions further direct the computing apparatus to incrementally decrease the scheduling weight of the UE in response to detecting that the throughput exceeds the target value until the throughput achieves the target value.

6. The computing apparatus of claim 1, wherein to modulate the allocation of network resources of the access node to the UE, the program instructions direct the computing apparatus to incrementally adjust a scheduling weight of the UE until the performance metric achieves the target value, wherein the performance metric comprises throughput.

7. The computing apparatus of claim 6, wherein a step size for incrementally adjusting the scheduling weight of the UE is determined based on a difference between the throughput and the target value.

8. The computing apparatus of claim 7, wherein the program instructions further direct the computing apparatus to determine that the allocation of network resources to the UE is adjustable based on the priority status of the UE in the priority domain.

9. A method of operating a wireless communication network comprising:
establishing network service, via an access node of the wireless communication network, for a user equipment (UE) according to a priority status of the UE with respect to a priority domain of the access node;
monitoring a performance metric of the network service for the UE with respect to a target value, wherein the target value is determined based on service requirements of the UE; and
in response to detecting a change in the performance metric based on the target value, modulating an allocation of network resources of the access node to the UE until the performance metric is within a specified margin of the target value.

10. The method of claim 9, wherein the allocation of network resources comprises an allocation of time-frequency units of the access node which are assigned to the UE and wherein the performance metric comprises throughput.

11. The method of claim 10, wherein modulating the allocation of network resources of the access node to the UE comprises incrementally adjusting a scheduling weight of the UE until the performance metric is within the specified margin of the target value.

12. The method of claim 11, further comprising maintaining the scheduling weight of the UE in response to detecting that the throughput achieves the target value.

13. The method of claim 12, further comprising incrementally decreasing the scheduling weight of the UE in response to detecting that the throughput exceeds the target value until the throughput achieves the target value.

14. The method of claim 10, wherein modulating the allocation of network resources of the access node to the UE comprises incrementally adjusting a scheduling weight of the UE until the throughput achieves the target value.

15. The method of claim 14, wherein a step size for incrementally adjusting the scheduling weight of the UE is determined based on a difference between the throughput and the target value.

16. The method of claim 15, further comprising determining that the allocation of network resources to the UE is adjustable based on the priority status of the UE in the priority domain.

17. One or more computer readable storage media having program instructions stored thereon that, when executed by one or more processors, direct a computing device to at least:
establish network service, via an access node of a wireless network, for a user equipment (UE) according to a priority status of the UE with respect to a priority domain of the access node;
monitor a performance metric of the network service for the UE with respect to a target value, wherein the target value is determined based on service requirements of the UE;
detect a degradation of the performance metric based on the target value; and
in response to detecting the degradation of the performance metric, modulate an allocation of network resources of the access node to the UE until the performance metric achieves the target value.

18. The one or more computer readable storage media of claim 17, wherein the network resources comprise time-frequency units of the access node which are assigned to the UE and wherein the performance metric comprises throughput.

19. The one or more computer readable storage media of claim 18, wherein to modulate the allocation of network resources of the access node to the UE, the program instructions direct the computing device to incrementally adjust a scheduling weight of the UE until the performance metric achieves the target value.

20. The one or more computer readable storage media of claim 19, the program instructions further direct the computing device to maintain the scheduling weight of the UE in response to detecting that the throughput achieves the target value.
